(19) United States
(12) Patent Application Publication
(10) Pub. No.: US 2018/0059731 A1
(43) Pub. Date: Mar. 1, 2018

(54) BACK COVER STRUCTURE AND ELECTRONIC DEVICE

(71) Applicant: PEGATRON CORPORATION, TAIPEI CITY (TW)

(72) Inventors: Hung-Yun Wu, Taipei City (TW); Shyh-Heh Hwang, Taipei City (TW); Ho-Ching Huang, Taipei City (TW); Hui-Chen Wang, Taipei City (TW); I-Tien Hsieh, Taipei City (TW)

(73) Assignee: PEGATRON CORPORATION, TAIPEI CITY (TW)

(21) Appl. No.: 15/597,966

(22) Filed: May 17, 2017

(30) Foreign Application Priority Data
Aug. 26, 2016 (TW) 105127374

(51) Int. Cl. G06F 1/16

(52) U.S. Cl. CPC G06F 1/1656; G06F 1/1616; G06F 1/1637

(57) ABSTRACT

A back cover structure for fixing a display unit includes a cover and a bezel. The cover includes an accommodating cavity and a first locking element. The bezel is pivoted to the cover close or expand relative to the cover. The bezel includes a second locking element corresponding to the first locking element. When the display unit is assembled to the accommodating cavity of the cover, the bezel is closed to the cover and exposes a display surface of the display unit, and the second locking element locks the first locking element, so as to fix the display unit and the bezel to the cover.

### CROSS-REFERENCE TO RELATED APPLICATION

This application claims the priority benefit of Taiwan application serial no. 105127374, filed on Aug. 26, 2016. The entirety of the above-mentioned patent application is hereby incorporated by reference herein and made a part of this specification.

### BACKGROUND

### Technology Field

The invention relates to a back cover structure and an electronic device. More particularly, the invention relates to a back cover structure capable of being assembled with a display unit and an electronic device using the back cover structure.

### Description of Related Art

Among notebook computers which are currently available on the market, in a scenario that one is formed by a tablet computer assembled with a host base, the tablet computer is directly inserted in a slot of the host base. Since the tablet computer and the host base are assembled only through the slot, received forces are concentrated in the slot, and as a result, issues in regard to product strength and insufficient reliability may rise.

### SUMMARY

The invention provides a back cover structure capable of increasing structural strength of a display unit.

The invention further provides a portable electronic device using the aforementioned back cover structure that can have preferable structural strength.

A back cover structure for fixing a display unit is provided by the invention. The back cover structure includes a cover and a bezel. The cover includes an accommodating cavity and a first locking element. The bezel is pivoted to cover to close or expand relative to the cover. The bezel includes a second locking element corresponding to the first locking element. When the display unit is assembled to the accommodating cavity of the cover, the bezel is closed to the cover and exposes a display surface of the display unit, and the second locking element locks the first locking element, so as to fix the display unit and the bezel to the cover.

In an embodiment of the invention, one of the first locking element and the second locking element is a hook, and the other one of the first locking element and the second locking element is a slot.

In an embodiment of the invention, the cover further includes a third locking element, and the third locking element is disposed opposite to the first locking element. The bezel further includes a fourth locking element corresponding to the third locking element, and the fourth locking element is disposed opposite to the second locking element.

In an embodiment of the invention, one of the third locking element and the fourth locking element is a hook, and the other one of the third locking element and the fourth locking element is a slot.

An electronic device including a main body, a back cover structure and a display unit is provided by the invention. The back cover structure is pivoted to the main body, so as to close or expand relative to the main body. The back cover structure includes a cover and a bezel. The cover includes an accommodating cavity and a first locking element. The bezel is pivoted to the cover to close or expand relative to the cover. The bezel includes a second locking element corresponding to the first locking element. The display unit is assembled to the accommodating cavity of the cover. The bezel is closed to the cover and exposes a display surface of the display unit, and the second locking element locks the first locking element, so as to fix the display unit and the bezel to the cover.

In an embodiment of the invention, one of the first locking element and the second locking element is a hook, and the other one of the first locking element and the second locking element is a slot.

In an embodiment of the invention, the cover further includes a third locking element, and the third locking element is disposed opposite to the first locking element. The bezel further includes a fourth locking element corresponding to the third locking element, and the fourth locking element is disposed opposite to the second locking element.

In an embodiment of the invention, one of the third locking element and the fourth locking element is a hook, and the other one of the third locking element and the fourth locking element is a slot.

In an embodiment of the invention, the cover further includes an electrical connection portion disposed in the accommodating cavity and electrically connected to the main body. The display unit is plugged in the electrical connection portion and electrically connected to the main body through the electrical connection portion.

In an embodiment of the invention, the display unit is a tablet computer.

Based on the above, the electronic device of the invention has the back cover structure pivoted to main body, and the display unit is assembled to the back cover structure. Thus, by being compared with the related art where the tablet computer is directly inserted on the host base, the back cover structure of the invention can cover the display unit to increase structural strength of the display unit, such that structural reliability of the overall electronic device can be enhanced.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a back cover structure pivoted to a main body according to an embodiment of the invention.

FIG. 2 is a schematic back diagram illustrating the back cover structure depicted in FIG. 1 pivoted to the main body.

FIG. 3 to FIG. 4 are schematic diagrams illustrating a display unit assembled to the back cover structure depicted in FIG. 1 to constitute an electronic device.

### DESCRIPTION OF EMBODIMENTS

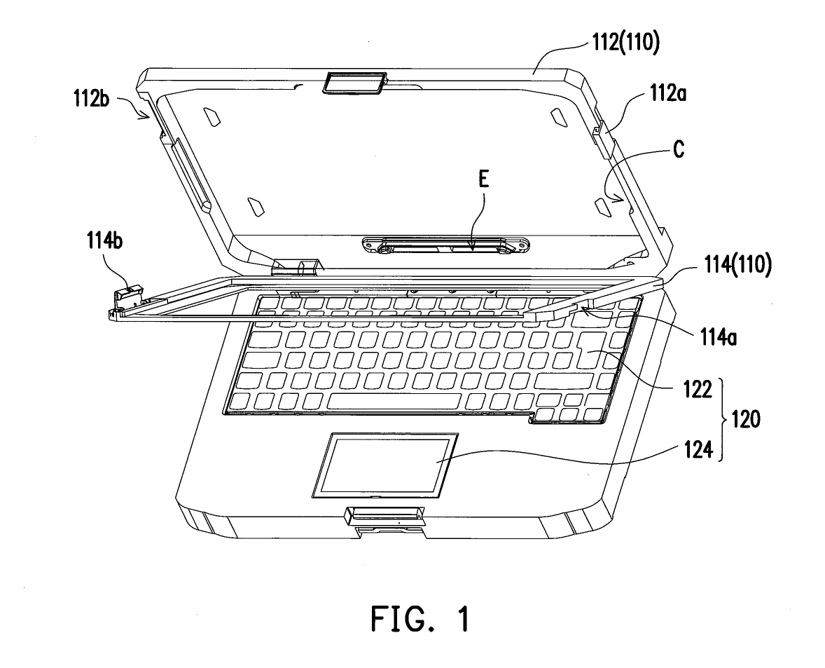

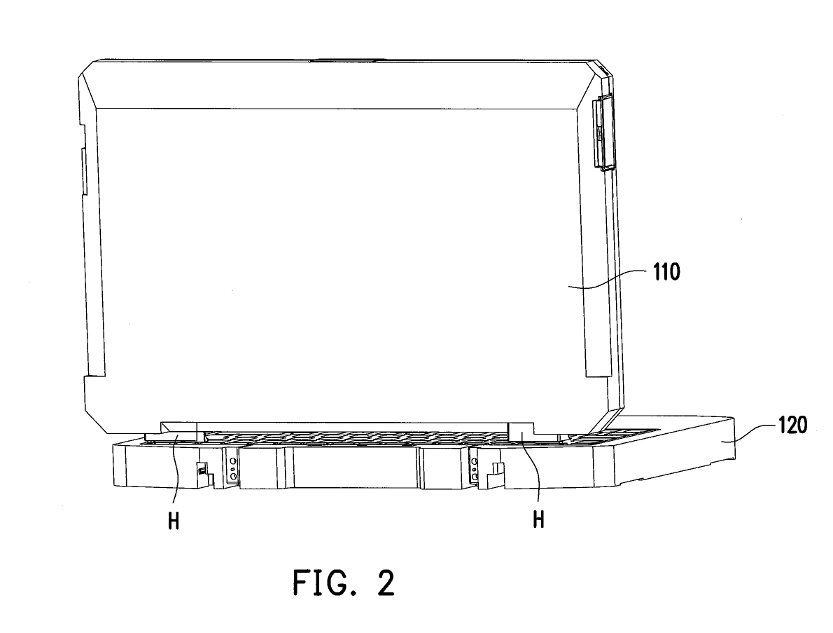

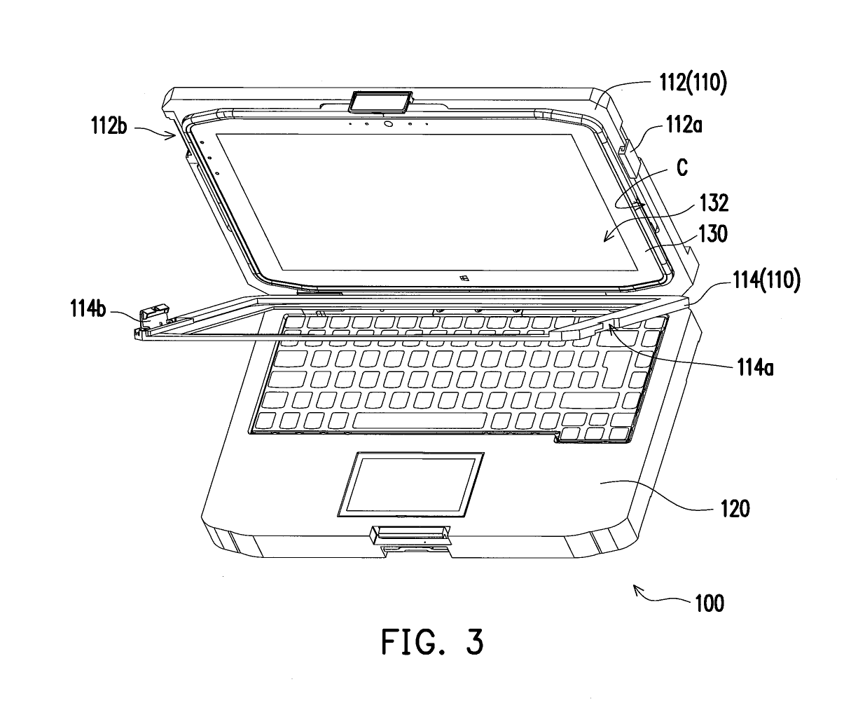

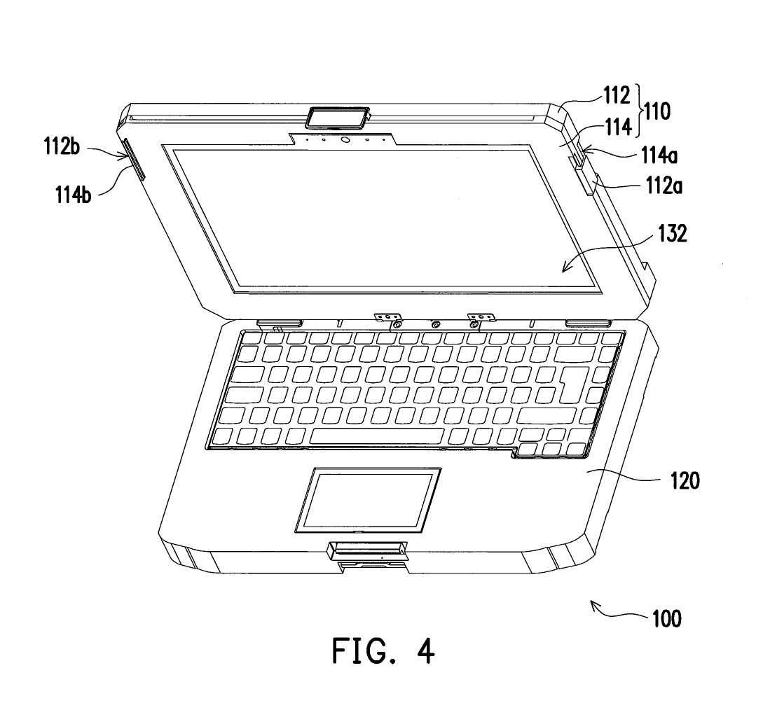

FIG. 1 is a schematic diagram illustrating a back cover structure pivoted to a main body according to an embodiment of the invention. FIG. 2 is a schematic back diagram illustrating the back cover structure depicted in FIG. 1 pivoted to the main body. FIG. 3 to FIG. 4 are schematic diagrams illustrating a display unit assembled to the back cover structure depicted in FIG. 1 to constitute an electronic device. Referring to both FIG. 1 and FIG. 2 first, a back cover structure 110 of the present embodiment is suitable for being pivoted to a main body 120 to close or expand relative to the main body 120. A notebook computer is taken as an example herein, and the main body 120 is, for example, a host part of the notebook computer on which an operation element (for example, a keyboard 122 or a touch panel 124) is disposed. The back cover structure 110 is pivoted to the main body 120 through, for example, a hinge H, but the invention is not limited thereto.

To be specific, referring to FIG. 1, FIG. 2 and FIG. 3, the back cover structure 110 of the present embodiment is used to fix a display unit 130 and includes a cover 112 and a bezel 114. The cover 112 includes an accommodating cavity C and a first locking element 112a. The bezel 114 is pivoted to the cover 112 to close or expand relative to the cover 112. The bezel 114 includes a second locking element 114a corresponding to the first locking element 112a. In this case, the bezel 114 is pivoted to the cover 112 through a hinge (which is not shown) to close or expand relative to the cover 112. The bezel 114 is, for example, a ring-shaped bezel, but the invention is not limited thereto. One of the first locking element 112a and the second locking element 114a is a hook, and the other one of the first locking element 112a and the second locking element 114a is a slot. As illustrated in FIG. 1, the first locking element 112a of the present embodiment is embodied as a hook, and the second locking element 114a is embodied as a slot. In other embodiments, the second locking element 114a may be a hook, and the first locking element 112a may be a slot, which pertains to a technical solution that can be adapted by the invention, without departing away from the scope to be protected by the invention.

Furthermore, in order to increase a fixing degree between the cover 112 and the bezel 114, the cover 112 of the present embodiment further includes a third locking element 112b. The third locking element 112b and the first locking element 112a are disposed opposite to each other. The bezel 114 further includes a fourth locking element 114b corresponding to the third locking element 112b. The fourth locking element 114b and the second locking element 114a are disposed opposite to each other. One of the third locking element 112b and the fourth locking element 114b is a hook, and the other one of the third locking element 112b and the fourth locking element 114b is a slot. As illustrated in FIG. 1, the third locking element 112b is embodied as a slot, and the fourth locking element 114b is embodied as a hook. In other embodiments, the fourth locking element 114b may be a slot, and the third locking element 112b may be a hook, which pertains to a technical solution that can be adapted by the invention, without departing away from the scope to be protected by the invention.

Additionally, in order to enable the display unit 130 and the main body 120 which are subsequently assembled to the back cover structure 110 to mutually transmit electrical signals, the cover 112 further includes an electrical connection portion E disposed in the accommodating cavity C and electrically connected to the main body 120.

Referring to FIG. 1 and FIG. 3 simultaneously, the display unit 130 is suitable for being assembled to the back cover structure 110, where the display unit 130 is plugged in the electrical connection portion E in the accommodating cavity C of the back cover structure 110, and the display unit 130 is electrically connected to the main body 120 through the electrical connection portion E. Herein, the display unit 130 is, for example, a tablet computer, but the invention is not limited thereto.

Referring to FIG. 3 and FIG. 4 simultaneously, when the display unit 130 is assembled in the accommodating cavity C of the cover 112, the bezel 114 is closed relative to the cover 112. In this circumstance, the bezel 114 exposes a display surface 132 of the display unit 130, while the second locking element 114a and the fourth locking element 114b respectively contact the first locking element 112a and the third locking element 112b and are respectively locked to the first locking element 112a and the third locking element 112b, such that the display unit 130 and the bezel 114 are fixed to the cover 112. In this way, an electronic device 100 is formed.

In brief, referring to FIG. 4 again, the electronic device 100 of the present embodiment includes the back cover structure 110, the main body 120 and the display unit 130. The back cover structure 110 is pivoted to the main body 120, so as to close or expand relative to the main body 120. The back cover structure 110 includes the cover 112 and the bezel 114. The cover 112 at least includes the accommodating cavity C and the first locking element 112a. The bezel 114 is pivoted to the cover 112 to close or expand relative to the cover 112. The bezel 114 at least includes the second locking element 114a corresponding to the first locking element 112a. The display unit 130 is assembled to the accommodating cavity C of the cover 112. The bezel 114 is closed to the cover 112 and exposes the display surface 132 of the display unit 130, and the second locking element 114a locks the first locking element 112a, such that the display unit 130 and the bezel 114 are fixed to the cover 112.

The bezel 114 of the back cover structure 110 is pivoted to the cover 112 in the present embodiment, such that the bezel 114 is capable of not only closing or expanding relative to the cover 112, but also covering the display unit 130 together with the cover 112. Thus, the back cover structure 110 of the present embodiment can effectively enhance structural strength of the display unit 130. In addition, the back cover structure 110 of the present embodiment is pivoted to the main body 120, while the display unit 130 is assembled on the back cover structure 110. Therefore, by being compared with the related art where the tablet computer is directly inserted on the host base, the display unit 130 of the present embodiment achieves the enhancement of the structural strength between the display unit 130 and the main body 120 through the design of the back cover structure 110, instead of by the display unit 130 structurally contacting the main body 120. Accordingly, the electronic device 100 of the present embodiment can have preferable structural reliability.

In light of the foregoing, since the electronic device of the invention has the back cover structure pivoted to the main body, and the display unit is assembled on the back cover structure, by being compared with the related art where the tablet computer is directly inserted on the host base, the back cover structure of the invention can cover the display unit to increase structural strength of the display unit, such that structural reliability of the overall electronic device can be enhanced.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A back cover structure for fixing a display unit, comprising:
a cover, comprising an accommodating cavity and a first locking element; and
a bezel, pivoted to the cover to close or expand relative to the cover and comprising a second locking element corresponding to the first locking element, wherein when the display unit is assembled to the accommodating cavity of the cover, the bezel is closed to the cover and exposes a display surface of the display unit, and the second locking element locks the first locking element, so as to fix the display unit and the bezel to the cover.

2. The back cover structure according to claim 1, wherein one of the first locking element and the second locking element is a hook, and the other one of the first locking element and the second locking element is a slot.

3. The back cover structure according to claim 1, wherein the cover further comprises a third locking element, the third locking element is disposed opposite to the first locking element, the bezel further comprises a fourth locking element corresponding to the third locking element, and the fourth locking element is disposed opposite to the second locking element.

4. The back cover structure according to claim 3, wherein one of the third locking element and the fourth locking element is a hook, and the other one of the third locking element and the fourth locking element is a slot.

5. An electronic device, comprising:
a main body;
a back cover structure, pivoted to the main body, so as to close or expand relative to the main body, the back cover structure comprising:
a cover, comprising an accommodating cavity and a first locking element; and
a bezel, pivoted to the cover to close or expand relative to the cover and comprising a second locking element corresponding to the first locking element; and
a display unit, assembled to the accommodating cavity of the cover, wherein the bezel is closed to the cover and exposes a display surface of the display unit, and the second locking element locks the first locking element, so as to fix the display unit and the bezel to the cover.

6. The electronic device according to claim 5, wherein one of the first locking element and the second locking element is a hook, and the other one of the first locking element and the second locking element is a slot.

7. The electronic device according to claim 5, wherein the cover further comprises a third locking element, the third locking element is disposed opposite to the first locking element, the bezel further comprises a fourth locking element corresponding to the third locking element, and the fourth locking element is disposed opposite to the second locking element.

8. The electronic device according to claim 7, wherein one of the third locking element and the fourth locking element is a hook, and the other one of the third locking element and the fourth locking element is a slot.

9. The electronic device according to claim 5, wherein the cover further comprises an electrical connection portion disposed in the accommodating cavity and electrically connected to the main body, wherein the display unit is plugged in the electrical connection portion and electrically connected to the main body through the electrical connection portion.

10. The electronic device according to claim 5, wherein the display unit is a tablet computer.
